(19) United States
(12) Patent Application Publication
(10) Pub. No.: US 2022/0029260 A1
(43) Pub. Date: Jan. 27, 2022

(54) FILTER AND METHOD FOR MANUFACTURE OF FILTER

(71) Applicant: FUJIKURA LTD., Tokyo (JP)

(72) Inventor: Yusuke Uemichi, Sakura-shi (JP)

(73) Assignee: FUJIKURA LTD., Tokyo (JP)

(21) Appl. No.: 17/428,162

(22) PCT Filed: Mar. 9, 2020
(86) PCT No.: PCT/JP2020/009970

§ 371 Date: Aug. 3, 2021

(30) Foreign Application Priority Data
Mar. 14, 2019 (JP) 2019-047555

(51) Int. Cl. H01P 1/207; H01P 3/12

(52) U.S. Cl. CPC H01P 1/207; H01P 3/121

(57) ABSTRACT

The present invention achieves a filter that makes it possible to easily adjust a center frequency of a pass band. A filter (1) includes a post-wall waveguide (11) functioning as a resonator group consisting of a plurality of resonators (11a to 11e) that are electromagnetically coupled to each other. The post-wall waveguide (11) has a broad wall (first broad wall 112) that is provided with openings (112a to 112e) which allow opening of at least one resonator (11a to 11e) belonging to the resonator group. These openings (112a to 112e) are used to adjust a center frequency of a pass band of the filter (1).

### TECHNICAL FIELD

The present invention relates to a filter including a post-wall waveguide. The present invention also relates to a method for manufacturing such a filter.

### BACKGROUND ART

A plurality of resonators that are electromagnetically coupled to each other is known to function as a band-pass filter that selectively allows electromagnetic waves in a specific frequency band (hereinafter also referred to as “pass band”) to pass therethrough.

For example, Patent Literature 1 discloses a band-pass filter achieved by providing a plurality of resonators inside a waveguide tube. According to the band-pass filter disclosed in Patent Literature 1, a screw is inserted in a resonator so that a center frequency of a pass band can be adjusted by changing an amount in which the screw is inserted.

Furthermore, a post-wall waveguide is also known as a waveguide alternative to a waveguide tube. The post-wall waveguide is constituted by (i) a dielectric substrate, (ii) broad walls that cover respective two main surfaces of the dielectric substrate, and (iii) a post wall that is provided inside the dielectric substrate. In the post-wall waveguide, a domain that is surrounded by the broad walls and the post wall functions as a waveguide through which electromagnetic waves propagate. As compared with the waveguide tube, the post-wall waveguide has an advantage of being more easily made lighter, shorter, and lower in cost. Non-patent Literature 1 discloses a band-pass filter achieved by providing a plurality of resonators inside a post-wall waveguide.

### CITATION LIST

### Patent Literature

[Patent Literature 1]
Japanese Patent Application Publication, Tokukaihei, No. 8-162805

### Non-Patent Literature

[Non-Patent Literature 1]
Yusuke Uemichi, et. al, Compact and Low-Loss Bandpass Filter Realized in Silica-Based Post-Wall Waveguide for 60-GHz applications, IEEE MTT-S IMS, May 2015.

### SUMMARY OF INVENTION

### Technical Problem

However, a filter including a post-wall waveguide has a problem of making it difficult to adjust a center frequency of a pass band. For example, it is impossible to adjust the center frequency of the pass band by applying, to the filter including the post-wall waveguide, the technique disclosed in Patent Literature 1. This is because the insertion of the screw in the post-wall waveguide makes it highly likely that a dielectric substrate (for example, made of quartz glass) will be broken.

An aspect of the present invention has been made in view of the problems, and has an object to achieve a filter that includes a post-wall waveguide and that makes it easy to adjust a center frequency of a pass band.

### Solution to Problem

A filter in accordance with an aspect of the present invention is configured to include: a post-wall waveguide functioning as a resonator group consisting of a plurality of resonators that are electromagnetically coupled to each other, the post-wall waveguide having a broad wall that is provided with an opening which allows opening of at least one resonator belonging to the resonator group and which is used to adjust a center frequency of a pass band.

### Advantageous Effects of Invention

An aspect of the present invention makes it possible to achieve a filter that makes it easy to adjust a center frequency of a pass band.

### BRIEF DESCRIPTION OF DRAWINGS

FIG. 1 is a perspective view illustrating a configuration of a filter in accordance with Embodiment 1 of the present invention.

FIG. 2 is a partial cross-sectional view of the filter illustrated in FIG. 1.

FIG. 3 is a plan view of a post-wall waveguide of the filter illustrated in FIG. 1.

FIG. 4 is a graph showing a frequency characteristic of a transmission coefficient S (2, 1) of the filter illustrated in FIG. 1. In FIG. 4, a radius of an opening is changed from 100 μm to 400 μm in 25-μm steps.

### DESCRIPTION OF EMBODIMENTS

(Configuration of Filter)

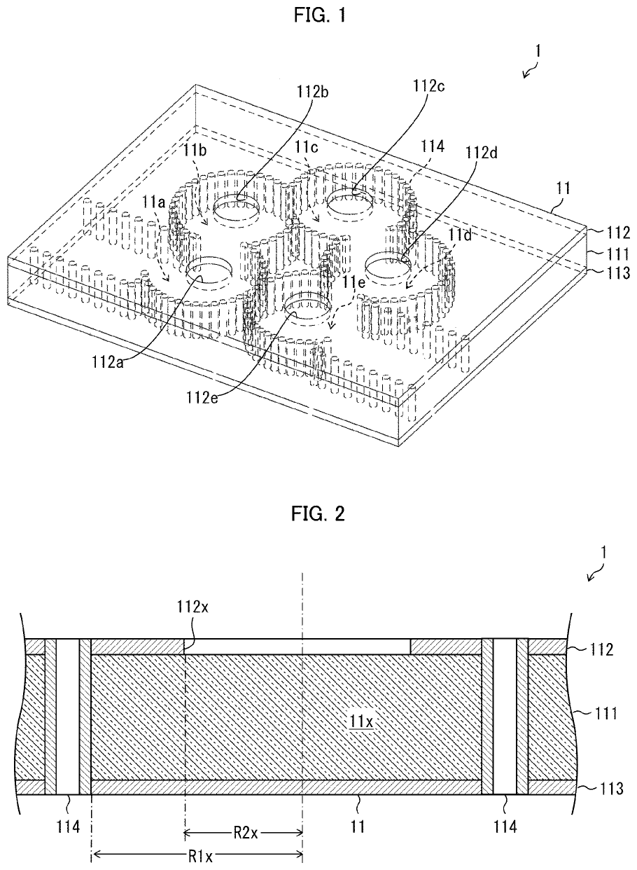

A configuration of a filter 1 in accordance with an embodiment of the present invention will be described with reference to FIGS. 1 and 2. FIG. 1 is a perspective view of the filter 1. FIG. 2 is a partial cross-sectional view of the filter 1.

The filter 1 includes a post-wall waveguide 11 functioning as a plurality of resonators 11a to 11e that are electromagnetically coupled to each other.

The post-wall waveguide 11 is constituted by (i) a dielectric substrate 111, (ii) a first broad wall 112 provided on a first main surface (an upper surface in each of FIGS. 1 and 2) of the dielectric substrate 111, (iii) a second broad wall 113 provided on a second main surface (a lower surface in each of FIGS. 1 and 2) of the dielectric substrate 111, and (iv) a post wall 114 provided inside the dielectric substrate 111.

The dielectric substrate 111 is a plate-like member that is made of a dielectric material. In the present embodiment, quartz glass is used as the dielectric material of which the dielectric substrate 111 is made. The dielectric substrate 111 that is made of quartz glass can have a thickness of, for example, 500 μm.

The first broad wall 112 and the second broad wall 113 are layered (or filmy) members made of a conductor material. In the present embodiment, copper is used as the conductor material of which the first broad wall 112 and the second broad wall 113 are made.

The post wall 114 is a collection of conductor posts that short-circuit the first broad wall 112 and the second broad wall 113 and that are arranged in a fence-like manner. An interval between the respective conductor posts that constitute the post wall 114 is sufficiently shorter as compared with a wavelength of electromagnetic waves that are received by the post-wall waveguide 11. Therefore, the post wall 114 functions as a conductor wall with respect to these electromagnetic waves. It is possible to set a diameter of the conductor posts to, for example, 100 μm, and to set the interval between the respective conductor posts to, for example, 200 μm. In the present embodiment, the conductor posts that constitute the post wall 114 are each achieved by providing a conductor layer on an inner wall of a through-hole that is through the dielectric substrate 111, or by filling the through-hole with a conductor. A pattern in which the post wall 114 is placed is determined so that a domain that is surrounded by the first broad wall 112, the second broad wall 113, and the post wall 114 functions as the plurality of resonators 11a to 11e that are electromagnetically coupled to each other. The pattern in which the post wall 114 is placed will be described later with reference to another drawing.

The first broad wall 112 of the post-wall waveguide is provided with openings 112a to 112e that are equal in number to the resonators 11a to 11e. Each resonator 11x (x=a, b, c, d, e) is electromagnetically coupled to a space outside the post-wall waveguide 11 (hereinafter referred to as an “external space”) via a corresponding opening 112x. Specifically, each opening 112x allows opening of a corresponding resonator 11x. In order that the resonator 11x and the external space will be coupled to each other with higher efficiency, the each opening 112x is provided so as to overlap with a center of the first broad wall of the corresponding resonator 11x when the first broad wall 112 is seen in plan view. In the present embodiment, the each resonator 11x has a columnar shape whose height extends in a direction that is orthogonal to the first broad wall 112, and the each opening 112x has a circular shape. (i) A radius R1x of a cross section (cross section parallel to the main surfaces of the dielectric substrate 111) of the each resonator 11x (hereinafter abbreviated as the radius R1x of the resonator 11x) and (ii) a radius R2x of the corresponding opening 112x are in the following relationship: R2x<R1x.

In the present embodiment, quartz glass is used as the dielectric material of which the dielectric substrate 111 of the post-wall waveguide 11 is made. However, an aspect of the present invention is not limited to this. The dielectric material of which the dielectric substrate 111 of the post-wall waveguide 11 is made can alternatively be any dielectric material different from quartz, such as sapphire or alumina.

In the present embodiment, copper is used as the conductor material of which the first broad wall 112 and the second broad wall 113 of the post-wall waveguide 11 are made. However, an aspect of the present invention is not limited to this. The conductor material of which the first broad wall 112 and the second broad wall 113 of the post-wall waveguide 11 are made can alternatively be, for example, aluminum or an alloy that is composed of a plurality of metallic elements.

In the present embodiment, the each resonator 11x has the columnar shape. However, an aspect of the present invention is not limited to this. The each resonator 11x can alternatively be in the shape of, for example, a prism whose cross section (cross section parallel to the main surfaces of the dielectric substrate 111) is a regular polygon that has at least six vertexes.

In the present embodiment, the each opening 112x has the circular shape. However, an aspect of the present invention is not limited to this. The each opening 112x can alternatively be in the shape of, for example, a regular polygon that has at least six vertexes.

In the present embodiment, the openings 112a to 112e are provided on the first broad wall 112 side. However, an aspect of the present invention is not limited to this. Specifically, the openings 112a to 112e can alternatively be provided on the second broad wall 113 side, or can be provided so as to separate into the first broad wall 112 side and the second broad wall 113 side. The scope of the present invention also encompasses, for example, a configuration in which the openings 112a, 112c, and 112e are provided on the first broad wall 112 side and the opening 112b and 112d are provided on the second broad wall 113 side.

In the present embodiment, the number of the resonators 11a to 11e and the number of the openings 112a to 112e are each set to five. However, an aspect of the present invention is not limited to this. Specifically, the number of the resonators 11a to 11e and the number of the openings 112a to 112e each can be any number that is two or more.

(Pattern in which Post Wall is Placed)

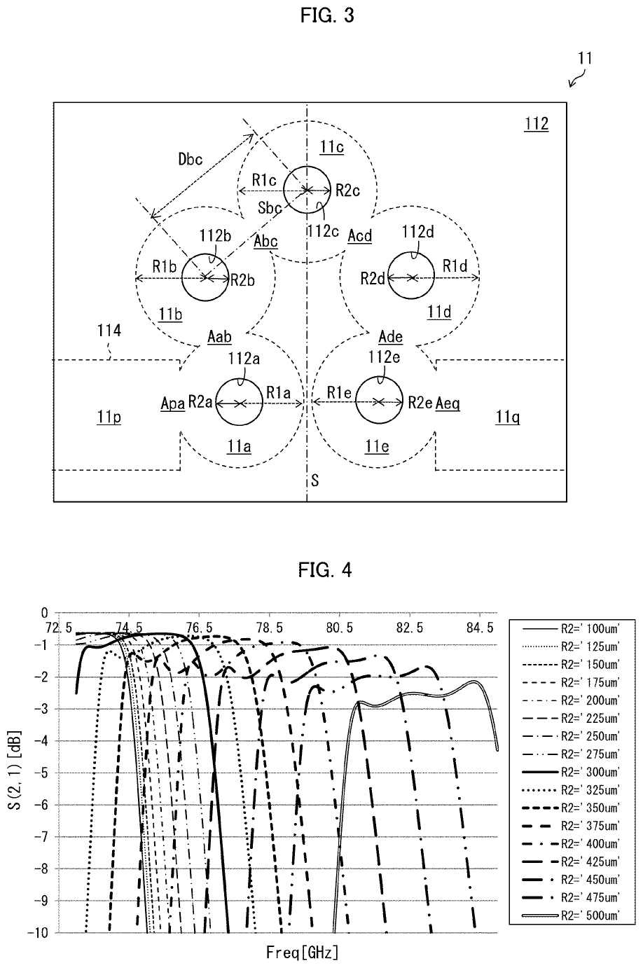

The pattern in which the post wall 114 is placed in the post-wall waveguide 11 will be described with reference to FIG. 3. FIG. 3 is a plan view of the post-wall waveguide 11. In FIG. 3, the post wall 114 is illustrated, with a dotted line, as an imaginary conductor wall.

The pattern in which the post wall 114 is placed is determined so that the domain that is surrounded by the first broad wall 112, the second broad wall 113, and the post wall 114 includes the following:
an input waveguide 11p;
the resonator 11a that is electromagnetically coupled to the input waveguide 11p via a coupling window Apa;
the resonator 11b that is electromagnetically coupled to the resonator 11a via a coupling window Aab;
the resonator 11c that is electromagnetically coupled to the resonator 11b via a coupling window Abc;
the resonator 11d that is electromagnetically coupled to the resonator 11c via a coupling window Acd;
the resonator 11e that is electromagnetically coupled to the resonator 11d via a coupling window Ade; and
an output waveguide 11q that is electromagnetically coupled to the resonator 11e via a coupling window Aeq.

The resonators 11a to 11e have the columnar shape, and the input waveguide 11p and the output waveguide 11q have a rectangular parallelepiped shape. A center-to-center distance between two resonators that are adjacent to each other (e.g., the resonator 11b and the resonator 11c) is smaller than a sum of radii of these two resonators. For example, a center-to-center distance Dbc between the two resonators 11b and 11c that are adjacent to each other satisfies the following: Dbc<R1b+R1c. Thus, the two resonators that are adjacent to each other are electromagnetically coupled to each other via the coupling window.

The two resonators that are adjacent to each other are symmetrical with respect to a plane containing central axes of these two resonators. For example, the two resonators 11b and 11c that are adjacent to each other are symmetrical with respect to a plane Sbc (see FIG. 3) containing central axes of these two resonators 11b and 11c. Furthermore, a resonator group consisting of the resonators 11a to 11e is symmetrical with respect to a specific plane S (see FIG. 3) that is orthogonal to the first broad wall 112. It is possible to easily design the filter 1 by giving such symmetry to the post wall 114 so as to reduce the number of independent parameters that define the pattern in which the post wall 114 is placed.

Moreover, (i) the resonator 11a that is coupled to the input waveguide 11p and (ii) the resonator 11e that is coupled to the output waveguide 11q are placed so as to be adjacent to each other. The resonators 11a to 11e as a whole are therefore arranged so as to have a loop shape. This allows the dielectric substrate 111 in which the post wall 114 is provided to be more compact. With the configuration, the dielectric substrate 111 can have a smaller absolute value of an amount of thermal expansion or thermal contraction of the dielectric substrate 111 that may occur during a change in ambient temperature. It is therefore possible to prevent or reduce a change in characteristic of the filter 1 which may occur, during the change in ambient temperature, due to thermal expansion or thermal contraction of the dielectric substrate 111.

In the present embodiment, a waveguide that is coupled to the resonator 11a is regarded as the input waveguide 11p, and a waveguide that is coupled to the resonator 11e is regarded as the output waveguide 11q. However, an aspect of the present invention is not limited to this. Alternatively, the waveguide that is coupled to the resonator 11a can be regarded as the output waveguide, and the waveguide that is coupled to the resonator 11e can be regarded as the input waveguide.

(Function of Opening)

The filter 1 includes the post-wall waveguide 11 functioning as the plurality of resonators 11a to 11e that are electromagnetically coupled to each other. The filter 1 therefore functions as a band-pass filter that selectively allows electromagnetic waves belonging to a specific frequency band (hereinafter referred to as “pass band”) to pass therethrough. The openings 112a to 112e are used to adjust a center frequency of this pass band.

FIG. 4 is a graph showing frequency dependence of a transmission coefficient S (2, 1) of the filter 1. FIG. 4 shows results of numerical simulation carried out assuming that the dielectric substrate 111 is made of quartz, the dielectric substrate 111 has a thickness of 520 μm, the resonators 11a and 11e have the respective radii R1a and R1e of 800 μm, and the resonators 11b to 11d have the respective radii R1b to R1d of 840 μm.

FIG. 4 shows the transmission coefficient S (2, 1) of the filter 1 obtained by changing the radius R2x of the each opening 112x from 100 μm to 400 μm uniformly in 25-μm steps. It is understood from FIG. 4 that the center frequency of the pass band shifts to the higher frequency side as the each opening 112x has a larger radius R2x.

As described above, in the filter 1, the center frequency of the pass band is determined in accordance with the respective sizes of the openings 112a to 112e. Therefore, the filter 1 in which the center frequency of the pass band coincides with a desired frequency can be easily manufactured by carrying out, during manufacture of the filter 1, a step of changing the respective sizes of the openings 112a to 112e so as to adjust the center frequency of the pass band.

Aspects of the present invention can also be expressed as follows:

A filter in accordance with a first aspect of the present invention is configured to include: a post-wall waveguide functioning as a resonator group consisting of a plurality of resonators that are electromagnetically coupled to each other, the post-wall waveguide having a broad wall that is provided with an opening which allows opening of at least one resonator belonging to the resonator group and which is used to adjust a center frequency of a pass band.

The configuration makes it possible to easily adjust the center frequency of the pass band by changing the size of the opening.

In a second aspect of the present invention, a filter is configured such that, in the first aspect of the present invention, each of the resonators has the opening that is provided in the broad wall.

The configuration makes it possible to easily adjust the center frequency of the pass band by changing the size of the opening.

In a third aspect of the present invention, a filter is configured such that, in the first or second aspect of the present invention, when the broad wall is seen in plan view, the opening is provided so as to overlap with a center of a resonator that belongs to the resonator group and is opened by the opening.

The configuration makes it possible to electromagnetically couple a resonator and an external space to each other with higher efficiency. This makes it possible to more effectively adjust the center frequency of the pass band by changing the size of the opening.

In a fourth aspect of the present invention, a filter is configured such that, in any one of the first to third aspects of the present invention, the opening has a circular shape.

The configuration makes it possible to electromagnetically couple a resonator and an external space to each other with higher efficiency. This makes it possible to more effectively adjust the center frequency of the pass band by changing the size of the opening.

In a fifth aspect of the present invention, a filter is configured such that, in any one of the first to fourth aspects of the present invention, the resonators have a columnar shape whose height extends in a direction that is orthogonal to the broad wall.

The configuration makes it possible to electromagnetically couple a resonator and an external space to each other with higher efficiency. This makes it possible to more effectively adjust the center frequency of the pass band by changing the size of the opening.

A method for manufacturing a filter in accordance with a sixth aspect of the present invention is a method for manufacturing a filter in accordance with any one of the first to fifth aspects of the present invention, including: changing a size of the opening so as to adjust the center frequency of the pass band.

The method makes it possible to easily manufacture the filter in which the center frequency of the pass band coincides with a desired frequency.

### ADDITIONAL REMARKS

The present invention is not limited to the embodiments, but can be altered by a skilled person in the art within the scope of the claims. The present invention also encompasses, in its technical scope, any embodiment derived by combining technical means disclosed in differing embodiments.

### REFERENCE SIGNS LIST

1 Filter
11 Post-wall waveguide
111 Dielectric substrate
112 First broad wall
112a to 112e Opening
113 Second broad wall
114 Post wall
11a to 11e Resonator

1. A filter comprising:
a post-wall waveguide functioning as a resonator group consisting of a plurality of resonators that are electromagnetically coupled to each other,
the post-wall waveguide having a broad wall that is provided with an opening which allows opening of at least one resonator belonging to the resonator group and which is used to adjust a center frequency of a pass band.

2. The filter as set forth in claim 1, wherein each of the resonators has the opening that is provided in the broad wall.

3. The filter as set forth in claim 1, wherein, when the broad wall is seen in plan view, the opening is provided so as to overlap with a center of a resonator that belongs to the resonator group and is opened by the opening.

4. The filter as set forth in claim 1, wherein the opening has a circular shape.

5. The filter as set forth in claim 1, wherein the resonators have a columnar shape whose height extends in a direction that is orthogonal to the broad wall.

6. A method for manufacturing a filter recited in claim 1, comprising:
changing a size of the opening so as to adjust the center frequency of the pass band.
